(19) United States
(12) Patent Application Publication
(10) Pub. No.: US 2015/0351999 A1
(43) Pub. Date: Dec. 10, 2015

(54) HEATING AND VIBRATING PERSONAL MASSAGER WITH ACCOMPANYING COVER

(71) Applicant: Getting in the Mood, LLC, Akron, OH (US)

(72) Inventor: Beverly Brouse, Akron, OH (US)

(21) Appl. No.: 14/568,345

(22) Filed: Dec. 12, 2014

Related U.S. Application Data
(60) Provisional application No. 61/927,831, filed on Jan. 15, 2014.
(60) Provisional application No. 62/065,890, filed on Oct. 20, 2014.

(51) Int. Cl. A61H 23/02; A61H 19/00

(52) U.S. Cl. CPC A61H 23/0263; A61H 19/34; A61H 2201/0207; A61H 2201/169

(57) ABSTRACT

A non-penetrating, non-phallic shaped apparatus and cover for massaging and stimulating, comprising a massager housing having a generally ovoid shape, generally convex top and bottom, first and second rounded convex ends, a power source; at least one switch; a heating source; a vibrating source contained within the massager housing providing at least one level of vibration; a generally oval concave depression of sufficient depth shaped to cup and envelop a woman's clitoris; a cloth textile cover, comprising a textile pouch in the shape of a fingerless cover; a compartment sized to hold said massager housing.

### CROSS REFERENCE TO RELATED APPLICATIONS

This application claims the benefit of U.S. Provisional application No. U.S. 61/927,831 filed on Jan. 24, 2014, which is entitled “A non penetrating adult sex toy which consists of interchangeable clothe textile mittens/gloves that go over an oval/egg shaped hand held vibrator/warming device”, and U.S. Provisional application No. U.S. 62/065,890 filed on Oct. 20, 2014, which is entitled “Heating and Vibrating Personal Massager with Accompanying Cover” and are incorporated herein by reference.

### BACKGROUND OF INVENTION

The inventor came up with the invention while seeking help from a sexual health therapist, because, like many women her age, the inventor found herself struggling with getting in the mood for sex. Although she deeply loved her husband, she couldn't figure out why her desire for intimacy was nearly depleted. All she knew was her lack of sexual interest had caused a strain not only on her marriage but sleeping habits, family dynamics and even her work life. She learned how oral contraception, anti anxiety medication and fatigue all play a role in stifling ones sex drive.

Suspecting her hang-ups may be more than just physical, the inventor reached out to a sexual health therapist. Therapy revealed her religious upbringing inadvertently contributed to her current view on sex and associated feelings of guilt and shame. She also realized that sex was no longer a priority. Like many working mothers, sex had become just another chore on her to-do list. She was turned off by traditional adult toys, her search left her empty-handed. She believed some form of visual concealment would help alleviate the feelings of guilt and shame resulting from her religious upbringing.

### BACKGROUND

Personal massagers, also known as vibrators, are well known in the art. They come in a variety of shapes and sizes, perform different functionalities and operate on different power sources. What they all have in common, however, are their characteristics of being cold, one directional (in function and texture), hard, and lacking discretion in design. These marks hold true despite the many developments in shape, texture, color and strength. Prior art lacks interchangeable versatility in textiles and textures. As seen in U.S. patent application Ser. No. 14/018,070, textured surfaces with various patterns are not new to the art but the ability to provide various textiles interchangeably is an element not yet available.

Although heating features have been introduced, prior art (exclusively for sexual stimulation) shows only gloves or cylinder shaped massagers such as dildos and bullets (meant for insertion or penetration) having incorporated heating elements (U.S. patent applications Ser. Nos. 09/712,663 & 10/128,669).

U.S. Patent Application Publication No. 2014/0066925 by Howard teaches a textured glove that houses a vibration unit for external stimulation. The application also discloses a two part glove system with an outer and inner portion that can be separated for washing. Additionally, the outer glove configuration is disclosed to be usable with lubricants. This application does not teach a vibration unit that is capable of being used separately from the glove, and likewise does not disclose many of the features of such a unit.

U.S. Pat. No. 6,748,604 to Duboff et al. teaches a glove that includes massage elements in each of the fingertips of the glove. Each massage element includes a housing and a motor therein for vibrating the housing, a power source, such as a conventional or rechargeable battery, may be provided for powering the motors. Each massage element is electronically connected to the power source, and a securing means may be provided for securing the device to the hand of a user.

U.S. Patent Application Publication No. 2013/0116503 by Mertens et al. teaches an egg shaped unit with a thin end, a wide end, buttons to control variable speed settings, and is constructed out of plastic or silicone. This application also discloses a suction feature, a textured contact surface and being usable with lubricants. This reference does not teach any sort of textile cover or its features.

U.S. Patent Application Publication No. 2013/0053630 by Wail et al. teaches a vibration unit having a heating element internal to the vibration unit. This reference does not teach a textile cover or its components.

U.S. Pat. No. 7,938,789 to Imboden et al. teaches a massager with mating recharging base. It can be controlled via remote control, can be used with lubricants, and is fluid- and water-resistant. It does not teach any textile covers.

U.S. Pat. No. 6,599,236 to Castro teaches a dildo having a heating element within the shaft. The device is non-vibrating and requires insertion/penetration. It does not teach any textile covers.

U.S. Patent Application Publication No. 2004/0087881 by Gross teaches a vibrating, heated leather glove. The glove operates on electricity obtained from conventional wall sockets (heating element) and a 2-AA battery powered massage motor.

U.S. Patent Application Publication No. 2013/0331745 by Sedic teaches a personal massager and can also include a controller for controlling the operation of the massager. The massager includes a motor and can also include a wireless remote control that can include a motion sensor/accelerometer) for detecting motion of the controller (e.g., changes in orientation). The the output motor power, a vibration pattern, or another massage setting are adjusted based on the detected motion of the controller or massager. It does not teach any textile covers.

Chinese applications CN 203208321 U and CN 203329009 U teach a egg-shaped vibrators connect to an external power source and control. '321 teaches controlling the egg using a controller attached the device. The device can also play music while in use. '009 teaches controlling the egg using a mobile phone with a wired connection to the egg. Neither teach any kind of textile cover.

Prior art teaches vibrators/massagers that are cylinder or phallic shaped, have an average length between 6-9 inches, and a diameter of 2 to 3 inches are generally intended for insertion or penetration into the body.

Vibrators, on their own, regardless of shape or size carry with them, in more conservative communities, a negative social stigma and indiscretion that some women find difficult to overcome.

### SUMMARY OF INVENTION

The present invention provides a new and improved non-penetrating, non phallic shaped personal massager. The design allows for multi-functionality, the accompanied covers provide an array of interchangeable stimulating textiles as well as instant warmth, and when used together offer a soft, discreet and more sophisticated twist over traditional massagers.

In accordance with one embodiment of the invention there is a massager apparatus, comprising: a massager housing; a power source compartment contained within the massager housing; processer board with micro controller contained within the massager housing connected to power source compartment for controlling heating and vibration; a motor and weight contained within the massager housing connected to processer board with micro controller connected to the power source compartment for providing vibration and heat activated by outside controls in the form of buttons; heater boards within the massager housing connected to processer board with micro controller connected to the power source compartment for providing heat to both ends of massager interchangeably by use of outside controls in the form of buttons.

In another embodiment of the invention there are interchangeable textile covers, comprising; a cloth cover designed to fit over the hand with inside access to massager apparatus; a built-in pocket specifically designed for the massager apparatus constructed within the cloth textile cover; defined pattern of textile affixed on outside palm of cover positioned directly over built-in pocket which holds the massager apparatus.

### BRIEF DESCRIPTION OF THE DRAWINGS

These and other objects and features of the present invention will become apparent to the reader through a consideration of the Detailed Description of the Invention when considered in conjunction with the drawing figures in which:

FIG. 1 is a top view of the massager apparatus invention;

FIG. 2 is a side view of the massager apparatus;

FIG. 3 is a bottom view of the massager apparatus;

FIG. 4 is a front view of the massager apparatus;

FIG. 5 is a perspective view of the massager;

FIG. 6 is a partial cross section of the massager apparatus;

FIG. 7 is a partial exploded view of the top portion of the massager apparatus;

FIG. 8 is a partial cross section of the massager;

FIG. 9 is a side view of the textile cover showing the user's hand and the massager within;

FIG. 10 is a top view of the textile cover showing the user's hand within; and

FIG. 11 is a flowchart of the button press sequence(s).

### DETAILED DESCRIPTION OF INVENTION

There is provided herein a new and improved non-penetrating, non-phallic shaped vibrating and warming massager accompanied with a cloth textile cover. The device is designed for stimulation of the external erogenous zones (e.g. the clitoris) and not for internal use (i.e. penetration of the vagina). Unlike traditional vibrators, which are phallic shaped, and are significantly longer than they are wide, the present invention is shorter and wider; it is generally ovoid (i.e. ellipsoid, or egg-shaped). The term “non-penetrating” is intended to mean that, due to its ovoid shape, the length of the longest dimension of the device is approximately twice the width of the greatest diameter of a cross-section taken perpendicular to its longest dimension. In other words, it's approximately twice as long as it is wide (measured at its widest). In contrast, most traditional vibrators are phallic shaped, and 3-4 times (at least) longer than they are wide.

The vibrating and warming massager includes an internally contained motor, processor board, and two heater boards in which all are powered by an internal DC power source (e.g. three (3) AA batteries) housed in a battery compartment with removable closure. Coated with a relatively thin, bio-compatible coating of silicone, the massager's inside components are protected from moisture, water, and/or lubricants by the protective silicone finish. The cloth textile covers are made from breathable, high quality, and machine washable materials that are surged together for sturdy construction and lasting durability. The cover can be a glove, a sleeve, a mitten, and/or a mitt. A preferred embodiment uses a fingerless mitt, large enough to encompass the vibrating device and a woman's hand. As used herein, examples and illustrations are exemplary in nature and not intended to be limiting.

### Vibrating & Heating Massager

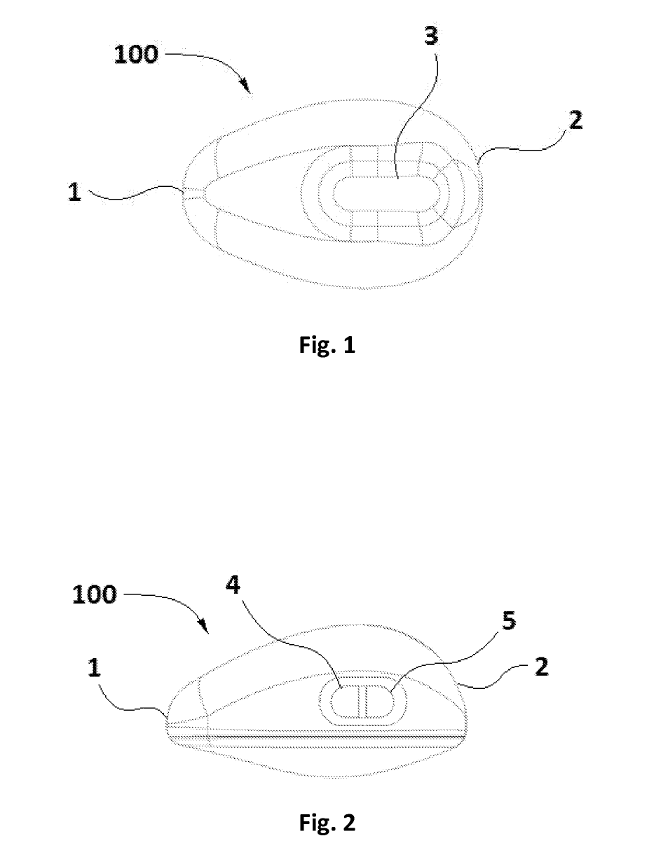

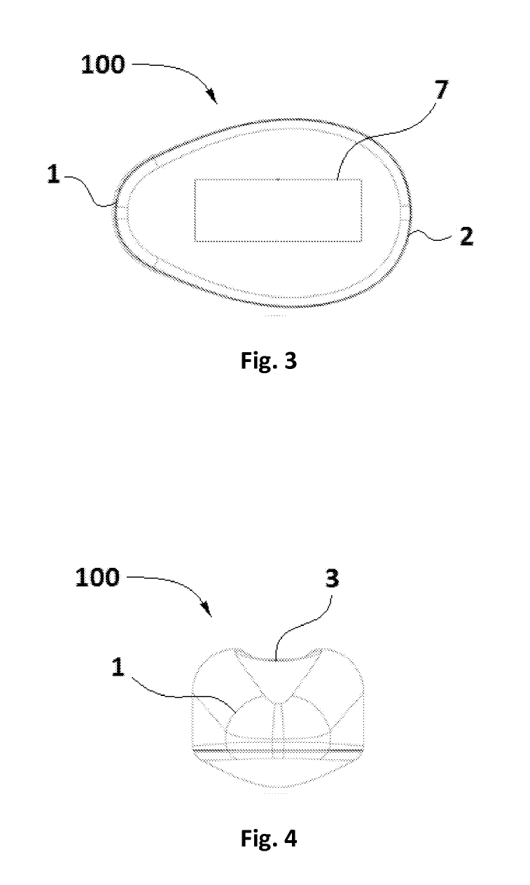

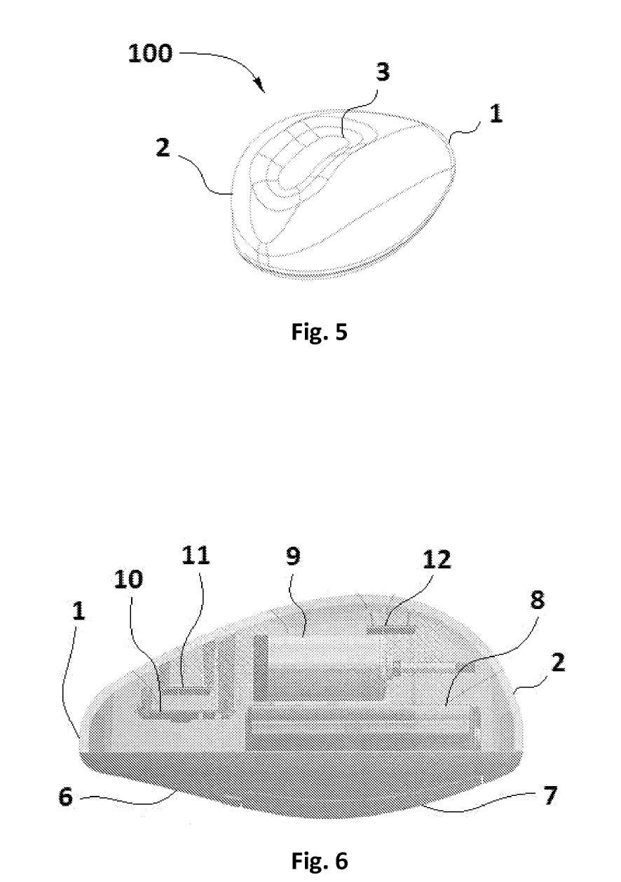

With reference to FIGS. 1-5, there is shown a new and improved non-penetrating, non-phallic shaped, ovoid vibrating and heating personal massager 100 measuring between 2 to 5 inches in length and 1.5 to 3 inches in width, preferably 3.7 inches in length and 1.9 inches in width. It is sized to fit in the palm of the hand. It features a smooth narrow end 1 for applying direct and concentrated pressure and where the first heater board 11 is located, as will be further discussed in FIG. 6. The wide end 2 has a wide leveled shape with a vertical concave cup or depression 3 designed to surround, envelop, and/or cup the clitoris for a vibrating, cupping sensation/stimulation. The wide end 2 houses the second heater board 12, as will be further discussed in FIG. 6, as well as a processor board 10 and motor 9. The figure shows a single motor, but the motor is not critical, and can be a single motor or a plurality of motors. A preferred embodiment features two vibrating motors, one located in the narrow end 1, the other located in the wide end 2.

The differentiating ends provide distinct variations of pressure. For example, the narrow end 1 allows for precise intensified force while the wide end 2, when placed directly over the clitoris, delivers a warm teasing sensation. The combination of these distinct features in one device allows for improved convenience and savings from not having to invest in multiple massagers.

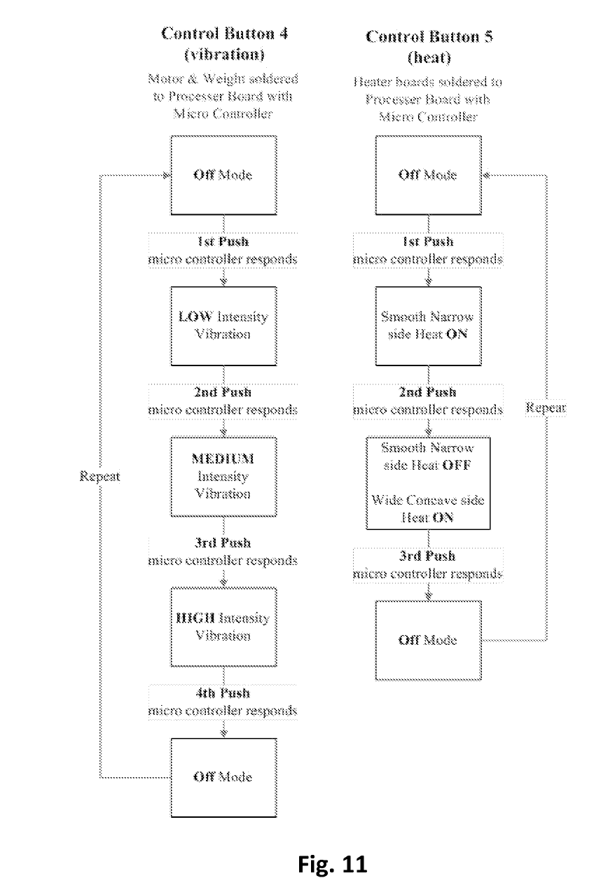

Further incorporated within the massager 100 are the controls, in the form of at least one button, but preferably two buttons 4, 5 preferably mirrored on both sides, but could be positioned on only one side. The buttons 4, 5 are visible and operable through the protective coating. With reference to FIG. 2 (see also, FIG. 11), the first button 4 operates the vibrating feature whose strength is governed by a battery powered motor and counter weight 9 connected to processor board 10 with a micro controller. The vibration means provides at least 1 level of vibration, with three distinct levels being preferred, and more than three being possible. The levels of vibration are tied to duty cycle. The term “duty cycle” is intended to mean the percentage of one period in which a signal is active. A period is the time it takes for a signal to complete an on-and-off cycle. As a formula, a duty cycle may be expressed as:

D=t/P×100%

where D is the duty cycle, t is the time the signal is active, and P is the total period of the signal. Thus, for example, a 60% duty cycle means the signal is on 60% of the time but off 40% of the time. The “on time” for a 60% duty cycle could be a fraction of a second, a day, or even a week, depending on the length of the period.

In the case of the present invention, three levels of vibration intensity are preferred, low, medium, and high. The low setting uses a 10-30% duty, where the time the signal is active (t) is between 0.050 ms-0.200 ms. The medium setting uses a 30-60% duty cycle with t between 0.200-0.400 ms. The high setting uses 100% duty cycle.

From the off mode, the micro controller responds to a push of the button 4 by activating a low intensity motion, of the motor while a second push commands the intensity to medium, followed by a high intensity for the third push. At high intensity, the micro controller responds to a fourth push by returning the motor off. An alternate embodiment includes a dial or knob or other analog control means to set the vibration at any level between 10% and 100% duty cycle.

The sister heating button 5 operates the heating feature through use of two heater boards 11, 12, and are also connected to the processor board 10. Heating can vary or stay constant. The preferred embodiment remains at a constant temperature of 45° Fahrenheit. The heater boards contain controls to limit their top temperature to 45° F. Such controls are known in the art and the exact means of control is not critical; any heat control will suffice. From the off mode, the micro controller again responds to a push of the second button 5 by activating constant heat to the narrow end 1 of the massager. A second push commands deactivation of the heat from the narrow end 1 and activates the heat on the wide end 2 while a third push returns the mode to off. FIG. 11 summarizes the button sequences. As noted, it possible to perform these functions with a single button to cycle though all possible vibration and heat combinations (i.e. first press activates first level of vibration, second press activates first vibration and heat, third press activates second level of vibration and disables heat, fourth press activates second vibration level and heat etc.), but because this would require numerous button presses to get to a user's preferred setting, two buttons as described above are preferred.

The bottom 6 has a convex design shape for a comfort fit inside palm while housing any conventional DC power source in a compartment with removable snap closure 7. The power source 8 is not critical and can be any known in the art, such as three AA batteries, a rechargeable battery, or wireless.

The bottom 6 contains a mechanism for attaching a wristband/cord, or other tether, which may take the form of two small holes for threading or a flush screw for fastening. The length of the cord is not critical; ½ inch or less is preferred.

With reference now to FIG. 6 there is shown the internal structure and battery 8 compartment. Internal structure includes motor and counter weight 9, heater boards 11, 12 composed of resistive elements that contain temperature protection circuitry, and a processor board 10 with micro controller in which the motor 9, heater boards 11, 12 and battery 8 compartment are directly soldered.

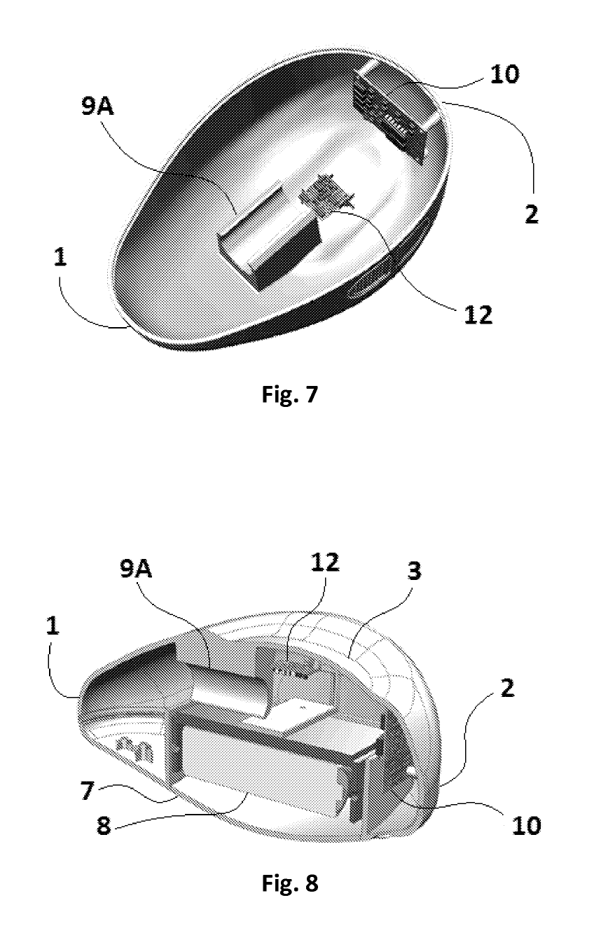

FIG. 7 shows the inside of the upper half of the body of the device. The wide end heater 12 can be seen affixed to the inner surface. Also shown is the vibrator motor housing 9A. The controller 10 can be seen attached to the wall of the wide end 2. This is an alternate location for the controller. The location of the controller is not critical and can be located in numerous places.

FIG. 8 shows a cross section of the device. The wide end heater 12 can be seen near the top, close to the depression 3. Also visible are the vibrator motor housing 9A, controller 10, and power source 8. Vibrator motor 9, and narrow end heater 11 are not shown.

The vibrating and heating massager 100 is coated with a thin, bio-compatible outside layer formed, for example, from silicone or a thermoplastic elastomer (TPE). The coating may be of varying thickness providing different levels of firmness or softness around the body of the device.

The described embodiment, with its versatile shape, is designed for use with the mitt cover 200, but is not limited to only this arrangement. For example, the massager 100 presented here, when used in conjunction with a matt-like apparatus (not shown), serves as the pressure point to the clitoris and provides the source of stability and friction for achieving missionary style, hands free self-stimulation.

The illustrated embodiment, personal massager 100 can take different aesthetic and/or functional shapes or forms, for example, forms which are larger or smaller in scale or forms which incorporate different colors or surfaces. The illustrated embodiment currently presented, provides a more discreet appearance by resembling a common household object, the computer mouse, while offering a chic and multifunctional purpose.

### Cloth Textile Cover

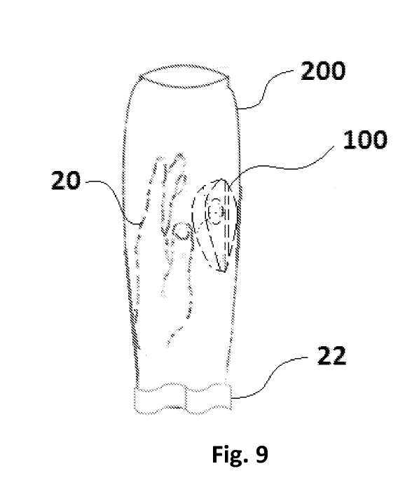

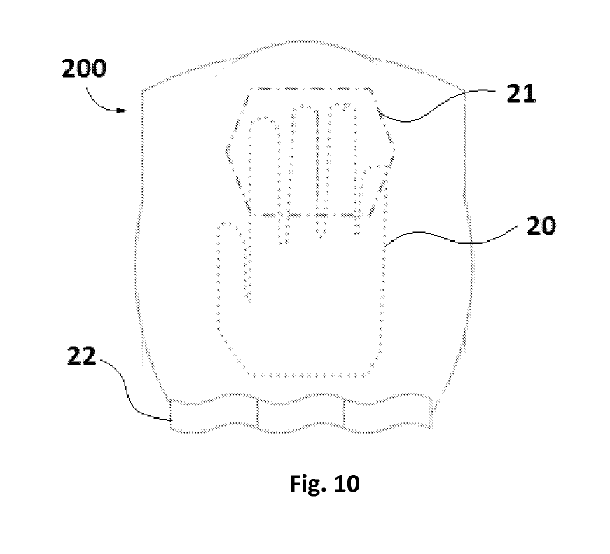

With reference now to FIGS. 9, 10 there is shown the cloth textile cover 200. The cover 200 is generally a fingerless cover to shroud the user's hand and the massager device 100. It can include a pocket or other means to separate and physically segregate the hand from the massager, preferably constructed with a built-in pocket 23 designed to hold the vibrating and heating massager 100. As used herein, the term “fingerless cover” in intended to describe a pouch with room for the user to insert her hand, and includes a mitt (no separate fingers/thumb) and a mitten (separate thumb, no fingers).

Access to pocket 23 may come from either inside or outside the cover. It further may or may not include some form of closure mechanism (i.e. zipper, Velcro, snaps, button, string/ribbon/bow, etc., or none at all). The pocket 23 is constructed such that the massager 100 lines up with the hand 20 when both are inserted into the cover 200. The cover 200 can be constructed without a pocket, requiring the user to hold the massager apparatus 100 directly in the palm 20A while placing the textile cover 200 over the hand 20 holding the massager apparatus. The cover has a material layer or appliqué 21 made from various textiles, patterns and textures. The appliqué 21 is positioned to line up with the massager apparatus when inside the cover to provide complimentary stimulation.

The exact dimensions of the cover are not critical. The preferred embodiment, measures approximately 9.25 inches in length and 7.5 inches in width, which provides sufficient room to comfortably fit a woman's hand in most cases. The cloth textile cover may also take form of a tailored slip-on cover that is designed to go over the massager apparatus directly. All cover versions are constructed out of anti-bacterial, treated machine washable fabrics, thread, preferably silk thread, elastic band, preferably V2 inch thick elastic band, and decorative lace and trim. The cover is constructed using an industrial serger and embroidery machine and consists of main components such as back side pattern made from anti-bacterial treated machine washable fabric, palm side pattern made from anti-bacterial treated machine washable fabric, inside lining pattern made from anti-bacterial treated machine washable fabric, appliqué 21 constructed from a variety of different textiles for each separate cover. These textiles include, but are not limited to, cotton, cotton blends, vinyl, vinyl with texture, polyester, polyester blends, corduroy, silk, and fleece, elastic band 22, and ribbon and/or trim that comes in different shapes, sizes, and textiles.

The appliqué 21 of various textiles and shapes provide versatility in sensations and enhances the vibration and stimulation experience. The various textures provide sensations that include, but are not limited to, soft and velvety, smooth and silky, rough and bumpy, slick and even prickly. Use of lubricants can also be used and are best applied to the smooth and silky textiles. This applique can be of any shape, including but not limited to, square, circle, triangle, polygon, heart, club, diamond, spade, chevron, oval, ellipse, Fleur de lis, and combinations thereof.

In lieu of an appliqué format, the versatile textiles may also come in the form of a removable tailored slip cover that fits snug around the massager apparatus. The slip cover provides a less bulky alternative yet allows for the same versatility and enhancement of sensations.

In the illustrated embodiment, cloth textile cover can take different aesthetic and/or functional shapes or forms, for example, forms which are larger, smaller in scale, with thumb or fingers in any combination or forms which incorporate different colors or textiles. The cloth textile cover provides instant softness and warmth when used in conjunction with the vibrating personal massager, and allows the user with a sense of discretion and comfort not typically associated with traditional prior art. The mitt cover, designed to fully conceal the hand and cover the pubic area, can provide relief of psychological discomfort and guilt associated with self-stimulation. While the hand is concealed, the act of masturbation becomes less visually obvious, which can make the act feel less dirty, sinful, and/or offensive.

While the invention has been shown and described with respect to particular embodiments, it is not thus limited. Numerous modifications, changes and improvements, within the scope of the invention, will now be apparent to the reader.

What is claimed is:

1. A non-penetrating, non-phallic shaped apparatus for massaging and stimulating, comprising:
a massager housing having a generally ovoid shape, generally convex top and bottom, first and second rounded convex ends,
a power source;
at least one switch;
a heating source;
a vibrating source contained within the massager housing providing at least one level of vibration
a generally oval concave depression of sufficient depth shaped to cup and envelop a woman's clitoris.

2. A cloth textile cover, comprising:
a textile pouch in the shape of a fingerless cover;
a compartment sized to hold the massager apparatus of claim 1.

3. The massager apparatus of claim 1 wherein the said vibrating source comprises a motor and weight connected to a battery powered processer board with micro controller within the massager housing.

4. The massager apparatus of claim 1 wherein the heating source includes custom made heater boards which contain temperature protection circuitry controlled by a battery powered processor board with micro controller.

5. The massager apparatus of claim 1 wherein the housing includes a means for wrist band attachment to secure the massager to a user's wrist.

6. The massager apparatus of claim 1 wherein the massager is inserted into a non-skid matt apparatus to allow for missionary style, hands free stimulation to the clitoris.

7. The cloth textile hand apparatus of claim 2 wherein the cover includes a textile pattern selected from an oval, a square, a circle, a chevron, a triangle, a heart, a rectangle, a polygon, a fleur de lis and combinations thereof.

8. The cloth textile cover of claim 2, further comprising an external texture.

9. The cloth textile cover of claim 8 wherein said external texture comprises soft and velvety, smooth, silky, rough, bumpy, slick, and prickly textures, and combinations thereof.

10. The massager apparatus of claim 1 wherein said heat source comprises first and second heating elements within the massager housing, the first heating element providing heat to the first end, the second heating element providing heat to the second end, wherein each said heating element can be selectively powered independently of the other heating element.

11. The cloth textile cover of claim 2 wherein said compartment is accessible from the outside.

12. The massager apparatus of claim 1, wherein said vibration source comprises first and second vibration motors, the first motor located in the first end, the second motor located in the second end, wherein each said motor can be selectively powered independently of the other motor.

13. A non-penetrating, non-phallic shaped apparatus and cover for massaging and stimulating, comprising:
a massager housing having a generally ovoid shape, generally convex top and bottom, first and second rounded convex ends,
a power source;
at least one switch;
a heating source;
a vibrating source contained within the massager housing providing at least one level of vibration
a generally oval concave depression of sufficient depth shaped to cup and envelop a woman's clitoris;
a cloth textile cover, comprising:
a textile pouch in the shape of a fingerless cover;
a compartment sized to hold said massager housing.
